(19) United States
(12) Patent Application Publication
(10) Pub. No.: US 2010/0001590 A1
(43) Pub. Date: Jan. 7, 2010

(54) ENERGY-SAVING ELECTRICAL ADAPTOR

(76) Inventor: Mark W. Litwack, West Chester, PA (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 12/496,839

(22) Filed: Jul. 2, 2009

Related U.S. Application Data
(63) Continuation of application No. 11/651,193, filed on Jan. 9, 2007.

(51) Int. Cl. H01H 47/00

(52) U.S. Cl. 307/131

(57) ABSTRACT

A power conservation apparatus having a power inlet for providing power to the power conservation apparatus and an external appliance, a power outlet operable to be connected to the appliance, a relay coupling the power inlet and the power outlet, a current sensor operable to measure a current flow from the power outlet to the appliance, a threshold detector operable to receive an input in accordance with the current flow and operable to determine if the appliance is in a state of non-use, and a timer having a set-point; wherein the timer is activated upon the appliance entering the state of non-use and wherein the relay is opened upon the timer reaching the set-point, so as to prevent the power conservation apparatus and the appliance from drawing power from the power inlet. When in the “off” state, the AC power consumed by the apparatus and coupled appliances is zero.

### CROSS-REFERENCE TO RELATED APPLICATIONS

This application is a continuation of U.S. application Ser. No. 11/651,193, filed on Jan. 9, 2007, the disclosure of which is incorporated herein by reference.

### BACKGROUND OF THE INVENTION

This invention relates to a power conservation device to be used in connection with a variety of electrical appliances.

Electrical appliances that are typically found in homes and business consume electricity even when the appliance is not in use, and many consume electricity even after the appliance appears to have been turned off. This is frequently referred to as the appliance's “stand-by” power, which is used to keep certain circuitry active and ready to respond to a potential user. Typically, the electricity drawn by appliances during the stand-by mode is only a small fraction of the electricity that is drawn when the appliance is in use. However, as many homes and businesses are switching to alternative energy sources, such as solar power, the need for lower levels of power consumption has become more important. An increasing strain has also been placed on standard power grids due to the proliferation of appliances that require a continuous stand-by power.

This is particularly a problem when appliances enter prolonged periods of non-use. For example, when the electrical appliances are in a second home which is not occupied throughout much of the year, the electricity used while the appliance is in stand-by mode can become significant. In order to avoid the waste that occurs while the appliance is not in use, the user must remember to unplug the appliance, or to turn off the power strip to which the appliance is connected. Users will often neglect to take such steps. An apparatus and method is therefore needed so as to provide a simple and inexpensive way to automatically prevent appliances from using power while they are in prolonged states of non-use.

### SUMMARY OF THE INVENTION

Embodiments of the present invention address such needs.

According to one embodiment of the present invention, a power conservation connector is used containing a power inlet for providing power to the power conservation apparatus and to an external appliance, a power outlet operable to be connected to the appliance, a relay coupling the power inlet and the power outlet, a current sensor operable to measure a current flow from the power outlet to the appliance, a threshold detector operable to receive an input in accordance with the current flow and operable to determine if the appliance is in a state of non-use, and a timer having a set-point; wherein the timer is activated upon the appliance entering the state of non-use and wherein the relay is opened upon the timer reaching the set-point, so as to prevent both the power conservation apparatus and the appliance from drawing power from the power inlet.

According to another embodiment of the present invention, the power conservation connector contains a remote control circuit that is operable to provide a control signal to the relay of the connector.

According to yet another embodiment of the present invention, the power conservation connector includes an external sensor, wherein the external sensor provides a signal corresponding to the appliance being in the state of non-use, and wherein the threshold detector is operable to determine if the appliance is in a state of non-use as based at least in part on the signal from the external sensor.

According to still another embodiment of the present invention, the power conservation connector includes a power inlet for providing power to the power conservation apparatus and a plurality of external appliances, a plurality of power outlets each operable to be connected to one of a plurality of appliances, a relay coupling the power inlet and the power outlets, a current sensor operable to measure a current flow from the power outlet to at least one monitored appliance, a threshold detector operable to receive an input in accordance with the current flow and operable to determine if the monitored appliance is in a state of non-use, and a timer having a set-point; wherein the timer is activated upon the monitored appliance entering the state of non-use and wherein the relay is opened upon the timer reaching the set-point, so as to prevent the power conservation apparatus and the plurality of appliances from drawing power from the power inlet.

According to still another embodiment of the present invention the power conservation connector includes an AC detector for detecting an AC voltage from the power inlet, a relay that is a fast acting non-latching relay, and an Opto Power TRIAC, wherein the AC detector stops drawing the AC voltage from the power inlet shortly after the AC voltage has been detected by the AC detector.

### BRIEF DESCRIPTION OF THE DRAWINGS

FIG. 1 illustrates a block diagram of an energy-saving electrical adaptor according to one embodiment of the invention;

FIG. 2 illustrates a flow chart of a method according to one embodiment of the invention;

FIG. 3 illustrates a block diagram of an energy-saving electrical adaptor having a second relay according to one embodiment of the invention;

FIG. 4 illustrates a block diagram of an energy-saving electrical adaptor having a remote control circuit according to one embodiment of the invention;

FIG. 5 illustrates a block diagram of an energy-saving electrical adaptor having an external sensor input according to one embodiment of the invention;

FIG. 6 illustrates a block diagram of an energy-saving electrical adaptor having a monitored and unmonitored appliance according to one embodiment of the invention;

FIG. 7 illustrates a block diagram of an energy-saving electrical adaptor having an AC detector and a fast-acting relay according to one embodiment of the invention;

FIG. 7(a) illustrates an AC detector circuit; and

FIG. 7(b) illustrates an opto power TRIAC.

### DETAILED DESCRIPTION

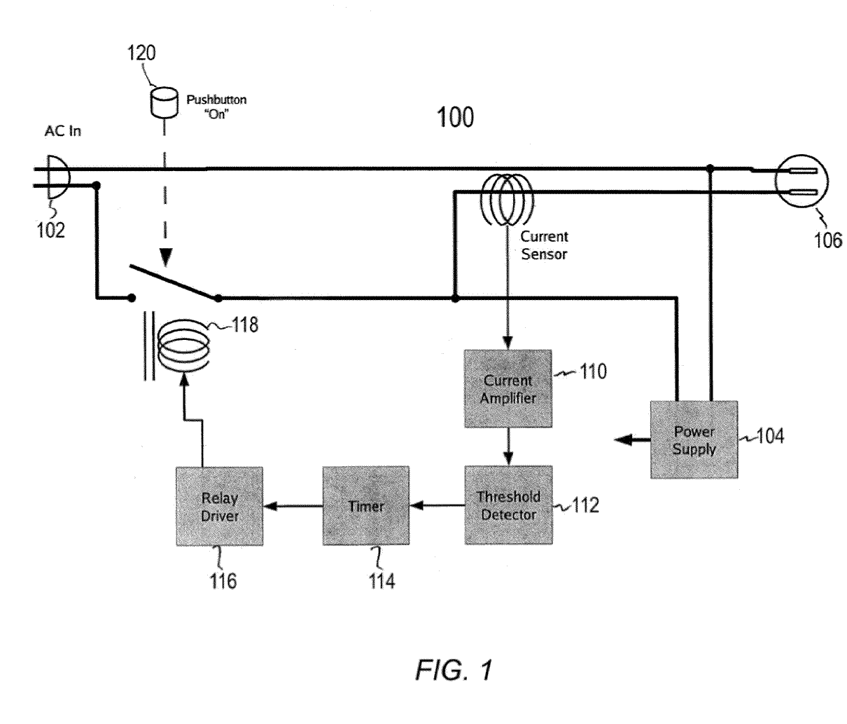

FIG. 1 illustrates a power connector 100 in accordance with one embodiment of the invention. In this embodiment, a relay is used in conjunction with a current sensor and a timer in order to completely deactivate an electrical device after a period of non-use, so that no power is drawn by either the electrical device or the power connector 100. As shown in FIG. 1, the power connector 100 includes an AC input 102 that is coupled to a power supply 104 and an AC outlet 106. A current sensor 108 is coupled to the AC outlet 106 so as to be operable to determine the current being drawn from the AC outlet 106. Connected to the current sensor 108 is a current amplifier 110, which is in turn connected to a threshold detector 112. The threshold detector 112 is coupled to a timer 114 so as to determine the period of time for which the current sensor 108 has detected a current that is below a predetermined threshold. The timer 114 is coupled to a relay driver 116, which is in turn coupled to a relay 118. The relay 118 is coupled to the AC input 102 and mechanically coupled to button 120.

In the operation of the power connector 100 the AC input 102 is connected to an AC power source, such as a standard 120V AC wall outlet. An electrical device or appliance (not shown) may then be connected to the AC outlet 106, so as to draw power from the AC input 102.

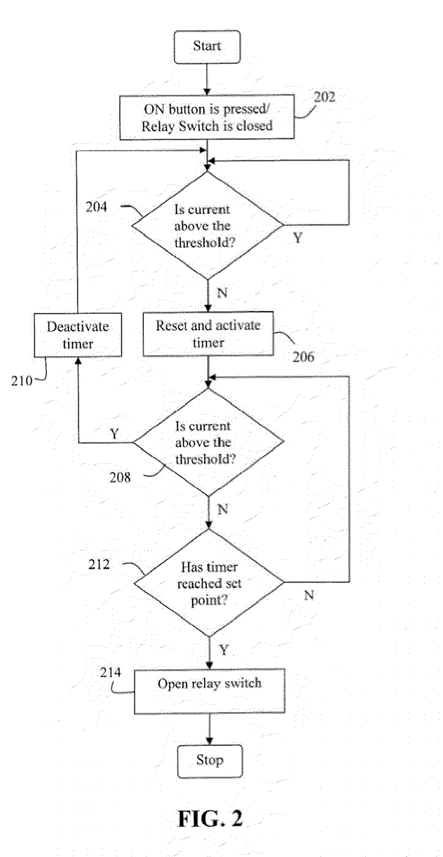

FIG. 2 illustrates the operation of the power connector 100 according to one embodiment of the invention. In step 202, the “ON” button 120 is pressed, so as to close the relay 118. The appliance attached to the AC outlet 106 may then operate as if it is directly connected to the AC power source. During this step, the power supply 104 will also draw AC power, which it will use to power the circuitry of the connector 100.

In step 204, the connector 100 determines whether the appliance is drawing a current that is above a predetermined threshold. During this step, the current sensor 108 outputs a signal in accordance with the current that is being drawn by the appliance. In turn, a current amplifier 110 may be used to amplify the output signal of the current sensor 108. The amplified signal is then received by the threshold detector 112 and is compared with a preset threshold level. The threshold level will typically be set between 0 and 1 Ampere, so that the current drawn by the appliance will be above the threshold only when the appliance is in use. While the appliance is in use, the output of the threshold detector 112 will continue to compare the current sensor 108 output with the preset threshold level. However, when the appliance enters a state of non-use, such as entering a standby mode, the current drawn by the appliance will drop below the preset threshold level, and the timer 114 is activated according to step 206.

Under step 208, the threshold detector 112 will continue to compare the output of the current sensor 108 with the threshold level. As long as the output of the current sensor 108 remains below the threshold, the timer 114 will remain activated, and steps 208 and 212 will be performed. However, if the appliance is turned on or taken out of the standby mode, the timer will be deactivated according to step 210, and the operation of the connector 100 will be brought back to step 204. Alternatively, if the timer 114 reaches the predetermined set point, then step 214 is performed, whereby the relay 118 is opened.

Upon the opening of the relay 118, no power will be drawn by either the appliance or the connector 100. The devices will remain in this state until an operator activates the connector 100 according to step 202, whereby the method illustrated in FIG. 2 is again performed. The embodiments shown in FIGS. 1 and 2 therefore provide a method and apparatus wherein energy may be conserved when the appliance enters a period of prolonged non-use, and which is achievable without the supervision of an operator.

The AC input 102 of the connector 100 may be either grounded or ungrounded. Additionally, the AC input 102 may be either integral to the connector 100 or connected by a cord. The relay 118 may be any device capable to prevent the flow of AC power to the AC outlet 106. Preferably, the relay 118 is a device that is not subject to large power loss at high currents, such as a latching bistable relay. The relay driver 116 may be any device operable to send a pulse of sufficient voltage or current so as to change the state of the relay 118 from a closed state to an open state. The current sensor may be any device capable of estimating the current flow to the connected appliance, such as a current sense transformer or a current shunt.

The threshold detector 112 may contain predetermined threshold levels, which may be selected by the operator depending on the type of appliance that is attached to the connector 100. Alternatively, the connector 100 may contain external controls (not shown) which are operable to configure the threshold detector 112 to a desired setting. In another embodiment, the threshold level may be set by the operator through a procedure whereby the user indicates to the connector 100 when the desired threshold has been reached. In this alternative, the operator will initially indicate when the appliance is in the standby mode versus when it is in use. The threshold detector 112 will then set the threshold between the current drawn during the standby mode and the current that is drawn during the use of the appliance. In yet another embodiment, the threshold level may be controlled by a microprocessor (not shown), which is accessible by a computer terminal.

The timer 114 may be either a digital or analog timer, and may contain predetermined timer settings. In one alternative embodiment, the connector 100 may contain external controls (not shown) which are operable to configure the timer 114.

In an alternative embodiment, many of the components of the connector 100 may be incorporated into a microprocessor, which itself may be continuously powered by a battery. For example, the timer 114, threshold detector 112, current amplifier 110 and the relay driver 116 may be incorporated into a single microprocessor. In addition the microprocessor may be accessible by an external computer terminal (not shown).

In some circumstances, the user may not desire the connector 100 to deactivate the appliance after a period of non-use. The connector 100 may therefore be programmed to allow power to flow to the appliance no matter what state the appliance is in. For example, the connector 100 may be programmed so that when the button 120 is pressed twice, in quick succession, the timer 114 will be deactivated, and power will continue to flow to the appliance even in prolonged states of non-use. The button 120 may then be pressed twice again to reactivate the timer.

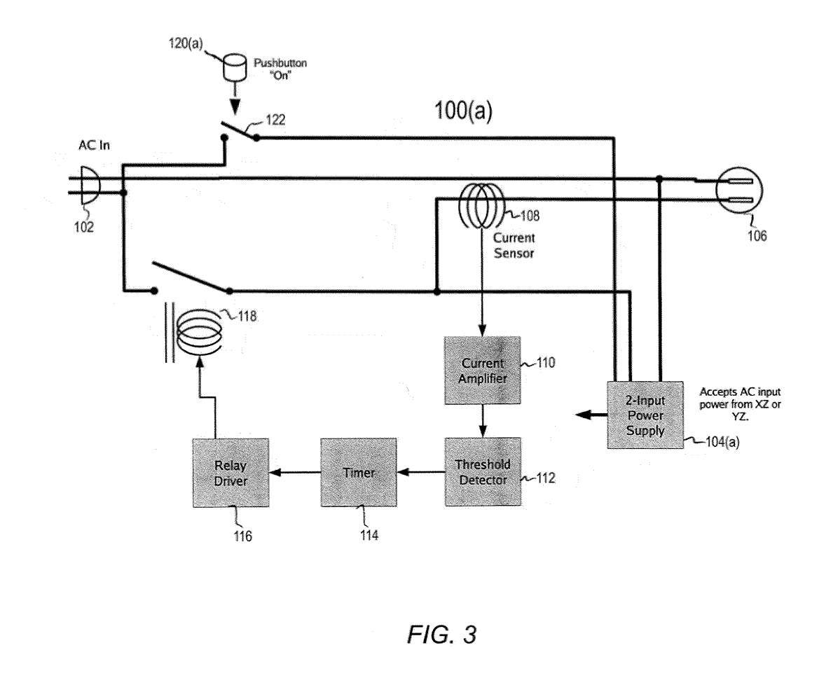

FIG. 3 illustrates an alternative embodiment, wherein the button 120(a) is not directly coupled to the relay 118. In this embodiment, the button 120(a) is coupled to a switch 122 operable to close the circuit between the AC input 102 and the power supply 104(a). The power supply 104(a) may then receive power from the AC input 102, and may in turn power the electronics contained in the connector 100(a). Upon receiving power, the relay driver 116 is initiated so as to close relay 118, thereby powering the connected appliance.

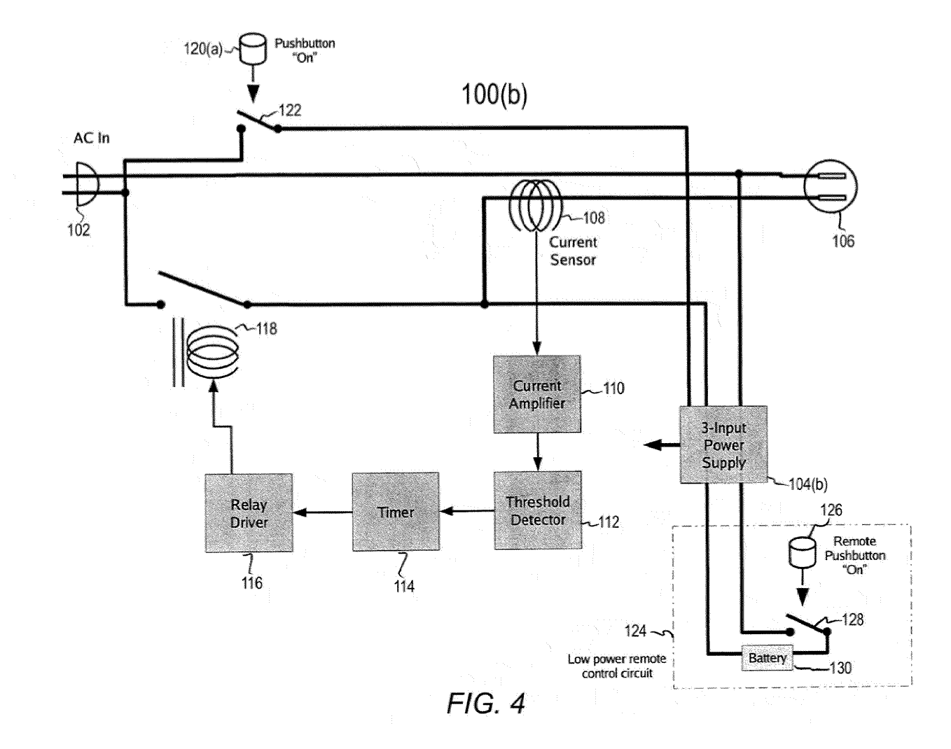

FIG. 4 illustrates an alternative embodiment, wherein a remote control circuit 124 may be used to activate the connector 100(b). In this embodiment, a remote control circuit 124 containing at least a button 126, a switch 128, and a battery 130 is coupled to the power supply 104(b) of the connector 100(b). The connector 100(b) may be activated by an operator pressing button 126, thereby closing switch 128. Upon switch 128 being closed, the battery 130 provides DC power to the power supply 104(b). The power supply 104(b) may then initiate the relay driver 116, which in turn closes the relay 118. The connector 100(b) may then perform the method of operation as described in FIG. 2. The battery 130 may be any battery sufficient to provide DC power to the power supply 104(c).

Often, the connector 100(b) will be located behind an appliance or will be in a location that is not easily accessible. However, the remote control circuit 124 of FIG. 4 may be placed next the appliance, thereby allowing an operator to easily activate the connector 100(b).

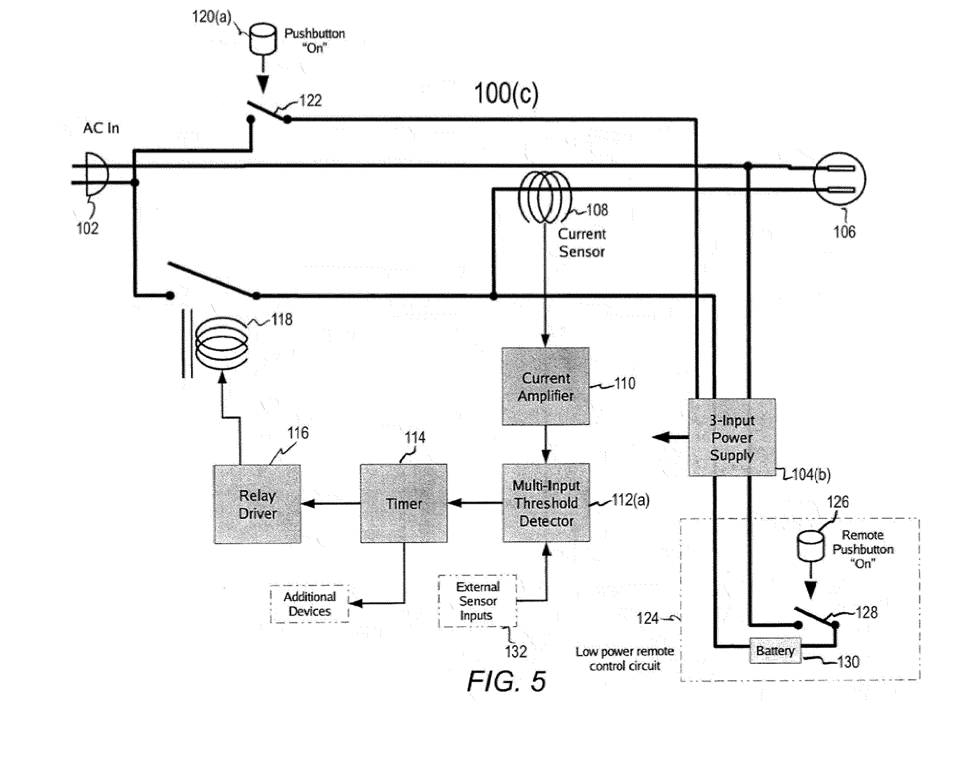

FIG. 5 illustrates an alternative embodiment, wherein the connector 100(c) is operable to receive multiple sensor inputs. As shown in FIG. 5, a multiple input threshold detector 112(a) is coupled to an external sensor 132 as well as the output of the current signal amplifier 110. The threshold detector may therefore activate the timer 114 according to multiple inputs. The external sensor 132 of FIG. 5 may be operable to create an output in accordance with the detection of motion, light, temperature or other indicators, and the threshold detector 112(a) may then be calibrated so as to identify certain outputs of the external sensor 132 as signifying that the appliance is in an idle state.

For example, the connected appliance may contain a light emitting diode (LED) that indicates whether the appliance is in use. In turn, the external sensor 132 may contain a light sensor operable to determine whether the LED is lit. In this embodiment, the method of operation as shown in FIG. 2 may be performed, whereby steps 204 and 208 include the threshold detector 112(a) determining whether the LED of the appliance is lit. Alternatively, the threshold detector 112(a) may be configured so as to compare each input it receives to a corresponding set point, and whereby each set point must be reached before the timer is either initiated or reset.

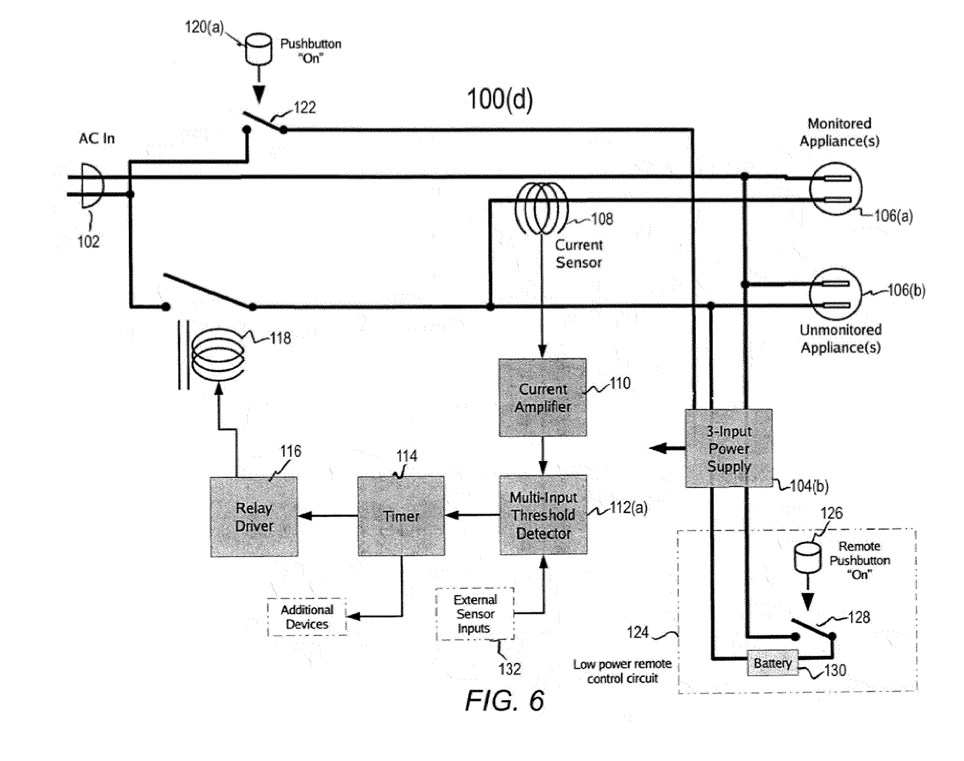

FIG. 6 illustrates an alternative embodiment wherein a plurality of appliances are connected to the power connector and wherein at least one appliance is not monitored by the power connector. In this embodiment, the connector 100(d) contains a plurality of AC outlets, such as AC outlet 106(a) and 106(b). Different appliances may then be connected to each of the AC outlets. During the operation of connector 100(d), the appliance that is connected AC outlet 106(a) is monitored by the current sensor 108, while the appliance connected to AC outlet 106(b) is not monitored. The method of operation as shown in FIG. 2 may then be used to determine when the monitored appliance has entered a prolonged state of non-use. Upon the monitored appliance entering a prolonged state of non-use, relay 118 is opened, thereby preventing both the monitored appliance and unmonitored appliance from drawing power.

The embodiment of FIG. 6 is beneficial for conserving power to multiple appliances that have related functions. For example, the use of a DVD player will often be directly related to the use of a television, so that the television may be connected to the connector 100(d) as the monitored appliance, while the DVD player is connected as the unmonitored appliance. During operation of the television, the DVD may also be used as if directly connected to the AC wall outlet. However, when the television enters a prolonged period of non-use, the connector 100(d) will prevent both the television and the DVD player from drawing power.

The connector 100(d) may include any number of monitored and unmonitored appliances, such that a plurality of unmonitored appliances may be controlled by the connector 100(d) in relation to one or more monitored appliance.

Many alternative energy sources, such as solar energy installations, require a high degree of energy conservation in order to be feasible as a reliable source of energy for a home or business. Therefore, the power conserving connectors embodied in the present application will frequently be used with such alternative energy sources that are not part of a standard utility grid. Many alternative energy installations store energy in batteries and utilize inverters to convert the energy stored in the battery so as to allow for the powering of AC appliances. However, an inverter becomes inefficient when no appliance is in use, in that the inverter will continue to consume a significant amount of power even when it is not powering an appliance. Therefore, many inverters are manufactured so as to enter a “sleep mode” when no appliances, which are connected to the inverter, are being used. Once the inverter has entered a sleep mode, it will periodically send an AC pulse to the connected AC appliances so as to determine if any appliance has been activated. If an appliance draws current during the AC pulse, the inverter will then resume normal operation and provide AC power to all appliances. If the connector 100 is to be used with such an inverter, its circuitry must be designed so as to allow the relay 118 to respond before the completion of the AC pulse cycle, which is typically on the order of 8 milliseconds for 60 Hz AC power.

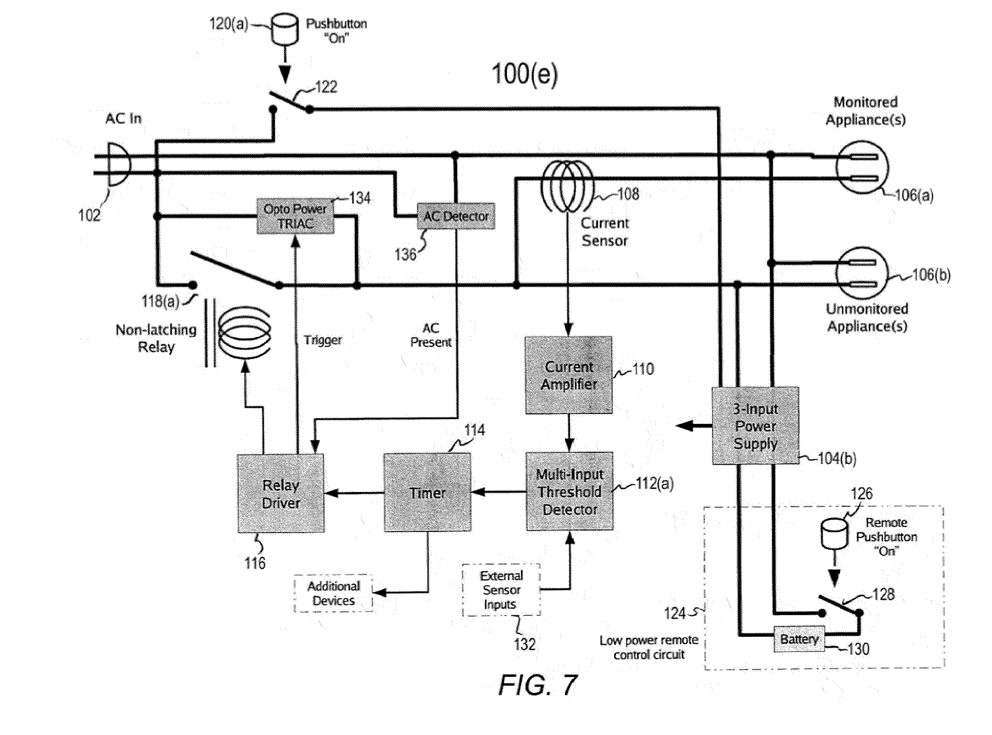

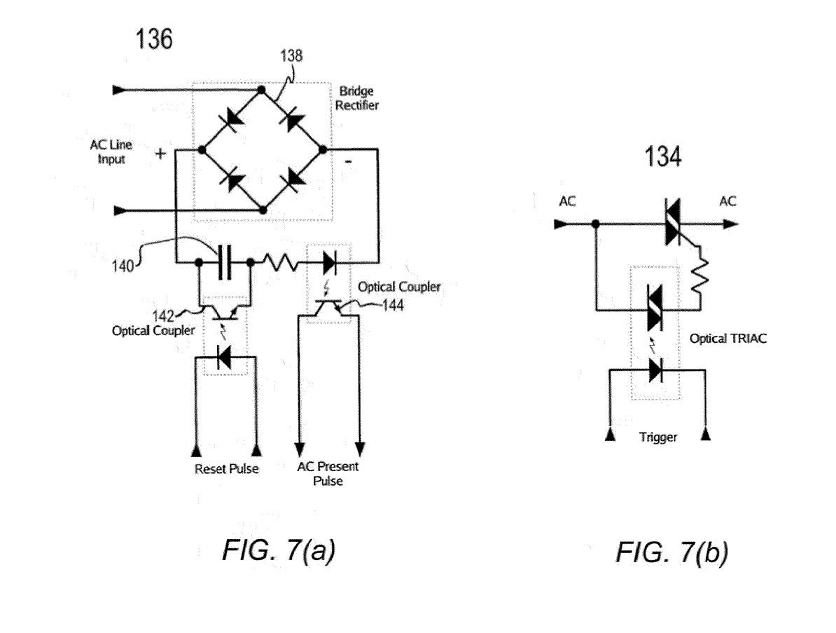

FIG. 7 illustrates an embodiment of the power conserving connector 100(e) that may be used with an energy-saving inverter. As shown in FIG. 7, the connector 100(e) contains a non-latching relay 118(a), an Opto Power TRIAC for alternating current 134, and an AC detector 136. The optically activated power TRIAC for alternating current, or Opto Power TRIAC 134, is connected in parallel with the non-latching relay 118(a) so as to create a fast-acting relay. An AC detector 136 is connected to the AC input 102 so as to detect the presence of an AC voltage from the AC input 102.

FIG. 8 illustrates an AC detector 136 that may be used in the connector 100(e). The AC detector contains an AC bridge rectifier 138, a capacitor 140, and two optical couplers 142 and 144. When an inverter (not shown) provides an AC voltage through the input 102, the AC bridge rectifier 138 provides a DC voltage to the capacitor 140. The DC voltage then builds on the capacitor 140, which in turn, causes the optical coupler 144 to produce an output signal. The output signal of the optical coupler 144, therefore represents that an AC line voltage is present over the AC input 102. However, as the capacitor 140 becomes fully charged, the current through the AC detector 136 will eventually diminish to zero, and the detector 136 will stop drawing power from the AC input 102. The AC detector 136 will therefore not draw any power during the continued operation of the connector 100(e) and the connected appliances. When the connector enters a state of non-use, a reset pulse can be provided to discharge the capacitor 140, so as to allow the AC detector 136 to detect another AC pulse from the inverter. Such a reset pulse may be provided by a microprocessor (not shown) in accordance with a programmed setting.

During a state of non-use, the inverter will provide the connector 100(e) with periodic AC pulses. Upon receiving the AC pulse, the AC detector 136 will provide a signal to the relay driver 116, thereby closing the fast-acting relay, which includes the non-latching relay 118(a) and the opto power TRIAC 134. If the attached appliance is activated so as to draw power from the AC pulse, the inverter will enter an active mode and provide a continuous AC current to the appliance. The AC detector 136 will then stop drawing current, as the capacitor 140 becomes fully charged. The connector 100(e) will then monitor the appliance via the current sensor 108 or external sensor inputs 132. Upon the appliance, entering a state of non-use for a period of time in accordance with the set-period of the timer 114, the relay driver 116 will open all relays contained in the connector 100(e), including the non-latching relay 118(a). The connector 100(e) therefore serves as an energy efficient device that may be used in connection with energy-saving inverters.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A power conservation apparatus comprising:
a power inlet for providing power to the power conservation apparatus and to an external appliance, a power outlet operable to be connected to the appliance, a relay coupling the power inlet and the power outlet, a current sensor operable to measure a current flow from the power outlet to the appliance, a threshold detector operable to receive an input in accordance with the current flow and operable to determine if the appliance is in a state of non-use, and a timer having a set-point; wherein the timer is activated upon the appliance entering the state of non-use and wherein the relay is opened upon the timer reaching the set-point, so as to prevent the power conservation apparatus and the appliance from drawing power from the power inlet.

2. A power conservation apparatus of claim 1 further comprising an external button, wherein the button is operable to close the relay.

3. A power conservation apparatus of claim 1 wherein the relay consists of a bistable-latching relay.

4. A power conservation apparatus of claim 1 further comprising a switch and an external button, wherein the switch is operable to provide power to the power conservation apparatus without providing power to the appliance, and wherein the external button is operable to close the switch.

5. A power conservation apparatus of claim 1 further comprising a remote control circuit and a non-remote circuit, wherein the remote circuit is operable to provide a control signal to the non-remote circuit, and wherein the relay is closed upon the non-remote circuit receiving the control signal.

6. A power conservation apparatus of claim 5 wherein the remote control circuit includes a control switch, a control button, and a battery.

7. A power conservation apparatus of claim 1 further comprising an external sensor, wherein external senor provides a signal corresponding to the appliance being in the state of non-use, and wherein the threshold detector is operable to determine if the appliance is in a state of non-use as based at least in part on the signal from the external sensor.

8. A power conservation apparatus of claim 1 wherein the threshold detector determines if the appliance is in a state of non-use by comparing the current flow with a programmable current threshold level.

9. A power conservation apparatus of claim 1 further comprising an AC detector for detecting an AC voltage from the power inlet, wherein the relay is operable to be a fast acting non-latching relay and is operable to close upon the AC detector detecting an AC voltage pulse, and wherein the AC detector is operable to stop drawing AC voltage from the power inlet after a continuous AC voltage has been detected.

10. A power conservation apparatus of claim 1 wherein the threshold detector is operable to be programmed by a user.

11. A power conservation apparatus of claim 1 wherein the timer set-point is operable to be programmed by a user.

12. A power conservation apparatus comprising:
a power inlet for providing power to the power conservation apparatus and a plurality of external appliances, a plurality of power outlets each operable to be connected to one of a plurality of appliances, a relay coupling the power inlet and the power outlets, a current sensor operable to measure a current flow from the power outlet to at least one monitored appliance, a threshold detector operable to receive an input in accordance with the current flow and operable to determine if the monitored appliance is in a state of non-use, and a timer having a set-point; wherein the timer is activated upon the monitored appliance entering the state of non-use and wherein the relay is opened upon the timer reaching the set-point, so as to prevent the power conservation apparatus and the plurality of appliances from drawing power from the power inlet.

13. A power conservation apparatus of claim 12 further comprising an AC detector for detecting an AC voltage from the power inlet, wherein the relay is operable to be a fast acting non-latching relay and is operable to close upon the AC detector detecting an AC voltage pulse, and wherein the AC detector is operable to stop drawing AC voltage from the power inlet after a continuous AC voltage has been detected.

14. A method for conserving power supplied to an appliance comprising the steps of:
a) monitoring a current flow from a power inlet to an appliance so as to determine if the appliance is in a state of non-use;
b) determining the period of time the appliance has been in the state of non-use; and
c) preventing all current flow from the power inlet upon the appliance being in the state of non-use for a predetermined period of time.

15. A method of claim 14 wherein the method is performed by a power connector such that a current flow to the power connector ceases upon performance of the preventing step of claim 14.

16. A method of claim 14 wherein the monitoring step includes monitoring a plurality of inputs corresponding to whether the appliance is in the state of non-use.

17. A method of claim 15 wherein the monitoring step includes monitoring a plurality of inputs corresponding to whether the appliance is in the state of non-use.

18. A method of claim 14 wherein the step of preventing current flow includes preventing current flow to a plurality of appliances.

19. A method of claim 15 wherein the step of preventing current flow includes preventing current flow to a plurality of appliances.
